(19) United States
(12) Patent Application Publication
(10) Pub. No.: US 2025/0149916 A1
(43) Pub. Date: May 8, 2025

(54) TRANSFORMER STATUS MONITORING USING FIBER SENSING

(71) Applicant: NEC Laboratories America, Inc., Princeton, NJ (US)

(72) Inventors: Zhuocheng JIANG, PLAINSBORO, NJ (US); Yue TIAN, PRINCETON, NJ (US); Yangmin DING, East Brunswick, NJ (US); Sarper OZHARAR, Pennington, NJ (US); Yanchao WANG, Princeton, NJ (US); Wataru Kohno, Princeton, NJ (US); Ting Wang, West Windsor, NJ (US)

(73) Assignee: NEC Laboratories America, Inc., Princeton, NJ (US)

(21) Appl. No.: 18/938,281

(22) Filed: Nov. 6, 2024

Related U.S. Application Data
(60) Provisional application No. 63/596,712, filed on Nov. 7, 2023.

(51) Int. Cl. H02J 13/00

(52) U.S. Cl. CPC H02J 13/00002; H02J 13/00017

(57) ABSTRACT

Disclosed are systems and methods directed to a frequency analysis approach to transformer status monitoring using distributed fiber optic sensing to monitor a phase delay of a 120 Hz vibrational signal and determining an angular difference between a designated point and a reference point. Operationally, systems and methods according to aspects of the present disclosure identify phase delay patterns of a single transformer from its vibrational humming and combined vibrational signals of multiple transformers.

### CROSS-REFERENCE TO RELATED APPLICATIONS

This application claims the benefit of U.S. Provisional Patent Application Ser. No. 63/596,712 filed Nov. 7, 2023, the entire contents of which is incorporated by reference as if set forth at length herein.

### FIELD OF THE INVENTION

This application relates generally to distributed fiber optic sensing (DFOS) systems, methods, structures, and related technologies. More particularly, it pertains to transformer status monitoring using fiber sensing.

### BACKGROUND OF THE INVENTION

Distributed fiber optic sensing (DFOS) systems, methods, and structures have found widespread utility in contemporary industry and society. Of particular importance, DFOS techniques have been used to usher in a new era of monitoring including perimeter security, traffic monitoring, and civil infrastructure monitoring. They can provide continuous, real-time measurements over long distances with high sensitivity, making them valuable tools for infrastructure monitoring and maintenance.

Transformer status assessment is crucial to ensure long-term reliability and efficiency of the electrical power supply system. Several components and parameters play an important role in monitoring the status of a transformer, such as temperature, oil quality/level, load and current, voltage, and vibration patterns.

### SUMMARY OF THE INVENTION

An advance in the art is made according to aspects of the present disclosure directed to a frequency analysis approach to transformer status monitoring using distributed fiber optic sensing,

In sharp contrast to the prior art, systems and methods according to aspects of the present disclosure monitor a phase delay of a 120 Hz vibrational signal—which, in out inventive systems and methods—the phase delay is a mechanical vibration measurement, determining an angular difference between a designated point and a reference point. Operationally, systems and methods according to aspects of the present disclosure identify phase delay patterns of a single transformer from its vibrational humming and combined vibrational signals of multiple transformers.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic flow diagram showing an illustrative operational flow of systems and methods according to aspects of the present disclosure.

FIG. 3 is a schematic diagram showing an illustrative experimental setup for transformer vibration data collection using fiber optic cable and distributed acoustic sensing interrogator according to aspects of the present disclosure.

FIG. 4(A) and FIG. 4(B) are plots of spectrograms of frequency vs time of DAS collected signals at two selected locations in which: FIG. 4(A) is a location equipped with a transformer; and FIG. 4(B) is a location without a transformer according to aspects of the present invention.

FIG. 5 is a schematic diagram showing illustrative transformer vibration simulations according to aspects of the present disclosure.

FIG. 6(A), FIG. 6(B), FIG. 6(C), and FIG. 6(D) are plots of phase delay vs distance showing phase shift across different locations with the location of the transformer signal source shown as a dotted line, in which: FIG. 6(A) shows only transformer signal1 is active; FIG. 6(B) shows only transformer signal2 is active; FIG. 6(C) shows both transformer signals are active and amplitude A=B; and FIG. 6(D) shows both transformer signals are active, and A≠B, according to aspects of the present disclosure.

FIG. 7 is a schematic diagram showing an illustrative experimental setup for transformer vibration data collection using fiber optic cable and distributed acoustic sensing interrogator according to aspects of the present disclosure.

FIG. 8(A), FIG. 8(B), and FIG. 8(C) are plots of phase difference vs location showing phase shift across different locations with the dotted line showing the location of the utility pole in which: FIG. 8(A) shows only transformer signal1 is active; FIG. 8(B) shows only transformer signal2 is active; and FIG. 8(C) shows both transformer signals are active, according to aspects of the present disclosure.

FIG. 9 is a schematic diagram showing illustrative features of systems and methods according to aspects of the present disclosure.

FIG. 10 is a schematic diagram showing an illustrative computer and system that may be integrated with and provide operational processing for systems and methods according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

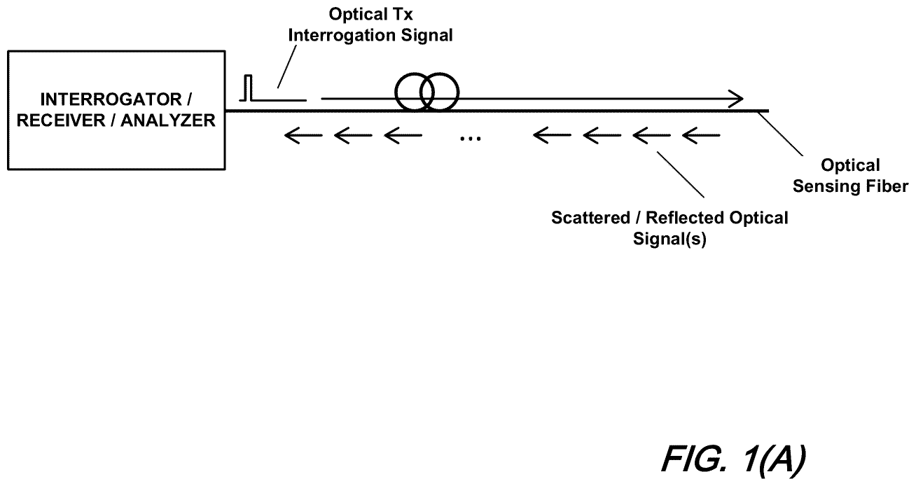

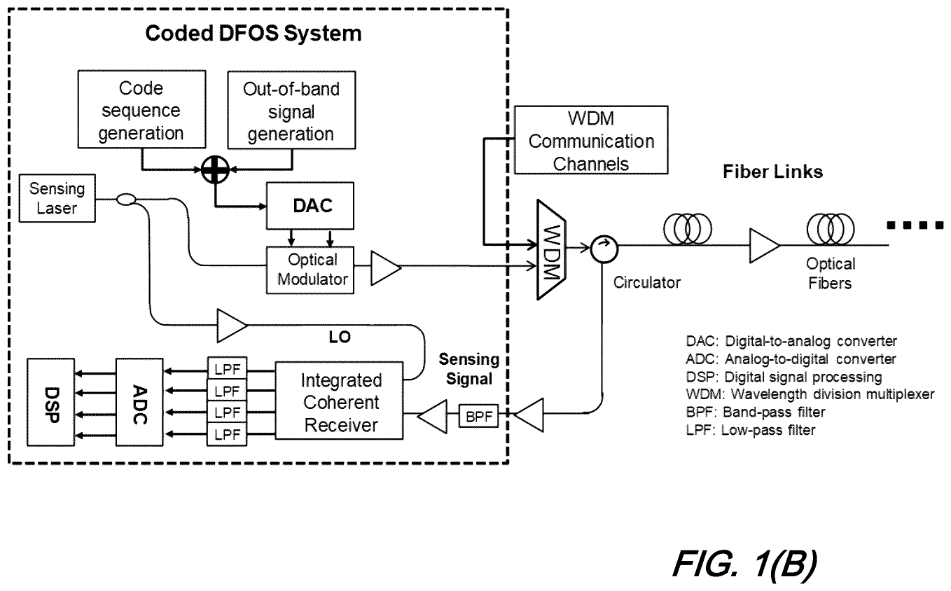

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Of particular interest, distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows for continuous monitoring over long distances, but instead of measuring temperature, it measures vibrations and sounds along the fiber.

DAS/DVS operates as follows.

Light pulses are sent through the fiber optic sensor cable.

As the light travels through the cable, vibrations and sounds cause the fiber to stretch and contract slightly.

These tiny changes in the fiber's length affect how the light interacts with the material, causing a shift in the backscattered light's frequency.

By analyzing the frequency shift of the backscattered light, the DAS/DVS system can determine the location and intensity of the vibrations or sounds along the fiber optic cable.

Similar to DTS, DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technology has a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

With the above in mind, we note once more that transformer status assessment is crucial to the long-term reliability and efficiency of the power supply system. Several components and parameters play an important role in monitoring the status of a transformer, such as temperature, oil quality/level, load and current, voltage, and vibration pattern.

Notably, monitoring and analyzing vibration patterns stands out as a pivotal measure. This approach facilitates early identification and resolution of issues, averting possible damage to the transformer

Transformers may produce vibrations for a variety of reasons, and the vibration frequency can differ depending on the root cause. A key point to consider is that magnetostriction typically results in a vibration frequency that's twice the supply frequency. Hence, in the US, with an electrical supply frequency of 60 Hz, the transformer vibration frequency induced by magnetostriction would be 120 Hz. In our research, we primarily focused on the frequency analysis at 120 Hz as indicators for transformer status monitoring. Leveraging the capability of a Distributed Acoustic Sensing (DAS) interrogator to capture the dynamic strain changes along the fiber in real time, our inventive systems and methods according to aspects of the present disclosure monitor the transformer's vibration. Since the mechanical vibrations from the transformer can propagate along the fiber cable from the source to further locations (could be hundreds of meters away), and the DAS interrogator is capable of capturing signals from every location along the fiber cable.

This presents a potential issue that the observed 120 Hz vibration frequency from a transformer at a particular location might be influenced by vibrations from transformers on adjacent poles. When this happens, the signals from the original transformer become mixed with others, making it challenging to determine the status of a single transformer without disentangling the merged signals. Turning to practical application, a unique situation needs to be considered where two transformers are mounted on two neighboring poles. Since they are close enough, even if one of the transformers stops humming, we may still see the 120 Hz signal from the other working transformer. Thus, our goal is to develop a method that allows for the effective monitoring of the status of both transformers

Since the mechanical vibrations from the transformer can propagate along the fiber cable from the source to further locations (could be hundreds of meters away), and the DAS interrogator is capable of capturing signals from every location along the fiber cable. This posts a potential issue that the observed 120 Hz vibration frequency from a transformer at a particular location might be influenced by vibrations from transformers on adjacent poles. When this happens, the signals from the original transformer become mixed with others, making it challenging to determine the status of a single transformer without disentangling the merged signals. Turning to practical application, a unique situation needs to be considered where two transformers are mounted on two neighboring poles. Since they are close enough, even if one of the transformers stops humming, we may still see the 120 Hz signal from the other working transformer. Thus, our goal is to develop systems and methods that provide for the effective monitoring of the status of both transformers

We describe a frequency analysis approach to address this specific scenario, mainly by monitoring the phase delay of the 120 Hz vibrational signal. Note that phase delay here is a mechanical vibration measurement, determining the angular difference between a designated point and a reference point. The objective is to identify the phase delay patterns of a singular transformer's humming and the combined vibration signals of multiple transformers. We begin with a simulation to establish a theoretical proof of concept. Subsequently, we conduct experiments on a real-scale testbed to validate our assumption.

There are several inventive features that our inventive systems and methods according to aspects of the present disclosure employ to solve the noted problems.

First, our experimental setup in the field test site located at Long Beach Island (LBI), New Jersey for real-world transformer humming sound vibration data analysis. This allows us to investigate the transformer vibration patterns more thoroughly, providing a clear insight into the problem.

Second, we conduct phase shift simulations to compare the variations in phase delay across different signal sources and locations, establishing a theoretical foundation.

Finally, performing an experimental test at our real-scale utility pole testbed for data collection and analysis. We set up a series of experiments to capture data from the DAS Interrogator and analyzed the phase delay in real-world scenarios

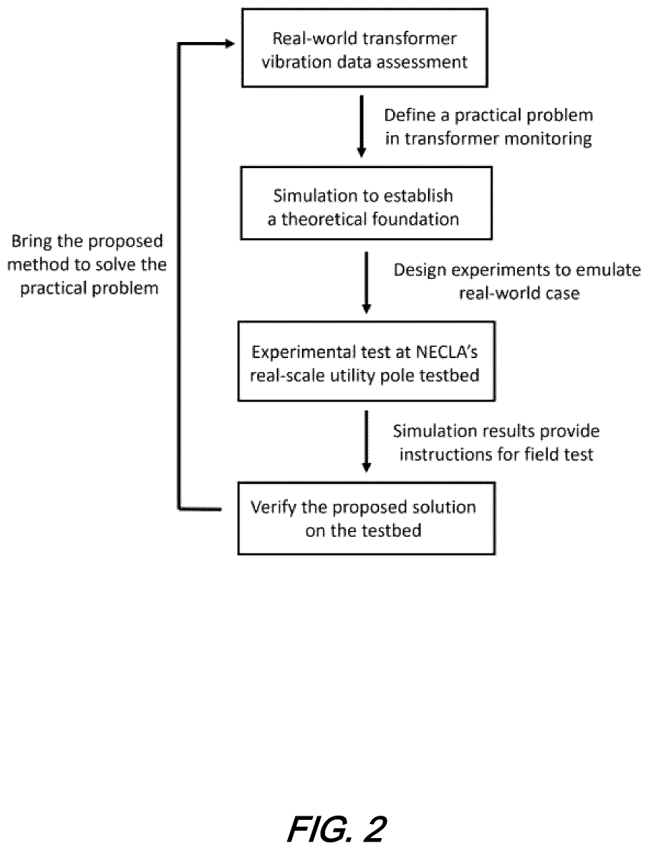

FIG. 2 is a schematic flow diagram showing an illustrative operational flow of systems and methods according to aspects of the present disclosure.

The challenge of accurately monitoring the status of transformers in our trials using fiber sensing data was initially identified. In response to this, we formulated a simulation approach. By utilizing sinusoidal waves to mimic the signals from transformers and calculating the phase delay as the signal propagates through the fiber cable. Taking it a step further, we executed an experimental test at our real-scale utility pole testbed. It allows us to control the transformer signal sources to validate a series of simulation results using fiber sensing technology

Step 1: Gather Real-World Humming Sound Vibrations from Transformers

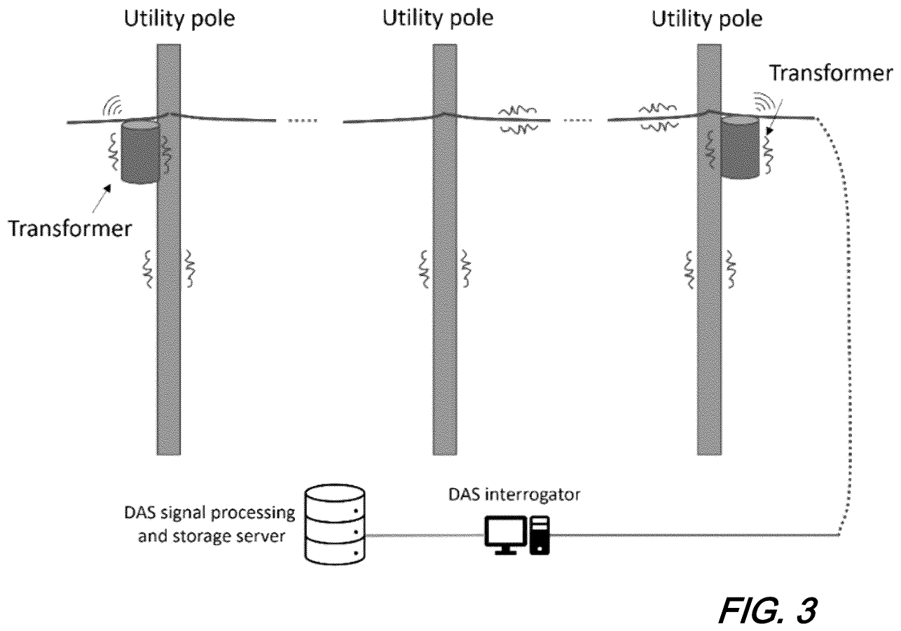

To demonstrate the capability of fiber sensing in transformer status monitoring, we used the DAS interrogator and fiber cable to gather real-world humming sound vibrations from transformers. The field test site was situated over a live telecommunications carrier's network. We identified two routes within residential zones, measuring 3.9 miles and 10 miles, respectively. Both routes are equipped with over ten pole-top transformers. The experimental setup is depicted in FIG. 3 which is a schematic diagram showing an illustrative experimental setup for transformer vibration data collection using fiber optic cable and distributed acoustic sensing interrogator according to aspects of the present disclosure. The transformer's humming sounds transmit through the fiber cable and the vibration disturbances at various locations are subsequently captured by the DAS interrogator connected to one end of the cable.

To determine the vibration pattern difference due to the presence or absence of a transformer, we compared data from two distinct locations: one with a transformer and the other without one.

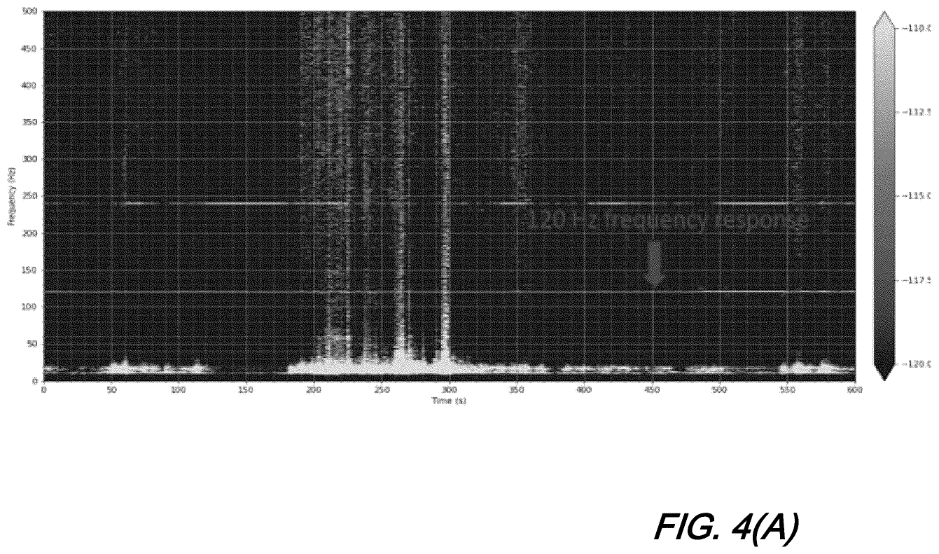

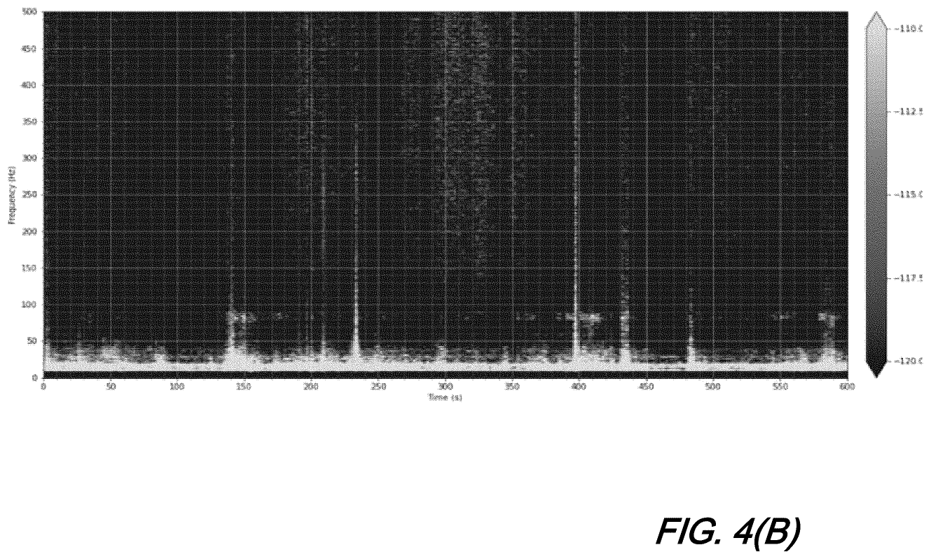

FIG. 4(A) and FIG. 4(B) are plots of spectrograms of frequency vs time of DAS collected signals at two selected locations in which: FIG. 4(A) is a location equipped with a transformer; and FIG. 4(B) is a location without a transformer according to aspects of the present invention.

These figures present the spectrogram of the signals collected by the DAS at the chosen locations. As we can see, in the spectrogram FIG. 4(A), we can observe the 120 Hz frequency, which arises from the transformer's humming vibration. On the contrary, FIG. 4(B) lacks this 120 Hz frequency, suggesting the absence of a transformer at that location. Furthermore, this 120 Hz humming signal property combining the presence of abnormal frequency components may serve as an indicator of transformer operation status and health condition.

However, a unique situation needs to be considered where two transformers are mounted on two neighboring poles. Since they are close enough, even if one of the transformers stops humming, one may still detect the 120 Hz signal from the neighboring, working transformer.

### Step 2: Phase Shift Simulations to Compare the Variations in Phase Delay

We employ a frequency analysis approach to address this specific scenario, mainly by monitoring the phase delay of the 120 Hz vibrational signal. For the phase delay simulation, we assume a fiber optic cable of 90 meters in length, with two transformers located at 30 meters and 60 meters from one end, respectively. The vibrational signals from these two transformers are defined as two 120 Hz sinusoidal waves: A*sin(2πft+π/4) and B*sin(2πft+π/3), where f=120 Hz, and π/4 and π/3 are random starting phases (when t=0) of the two vibrational signals. When the signal is activated, it will propagate in both directions along the cable.

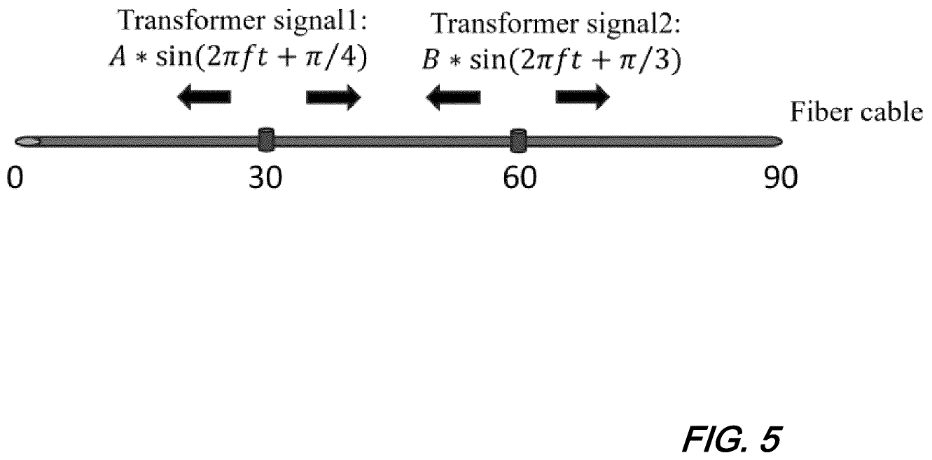

FIG. 5 is a schematic diagram showing illustrative transformer vibration simulations according to aspects of the present disclosure. The simulation illustrated in this figure is based on the unique situation described previously in Step 1.

Given our simulation setup, we evaluate the phase shift across four distinct cases: (1) Only transformer signal1 is active. (2) Only transformer signal2 is active. (3) Both signals are active, and signal amplitude A=B. (4) Both signals are active, and signal amplitude A≠B, where A=0.8 and B=1. When there's a singular signal source, the phase delay can be derived using the formula: φ(x)=2πxf/c, where x represents the distance to the signal source. For our simulations, we've set c (speed of sound in fiber) to 3000 m/s. In scenarios when both signal sources are active, we employ the Fast Fourier Transform (FFT) to determine the combined phase shift.

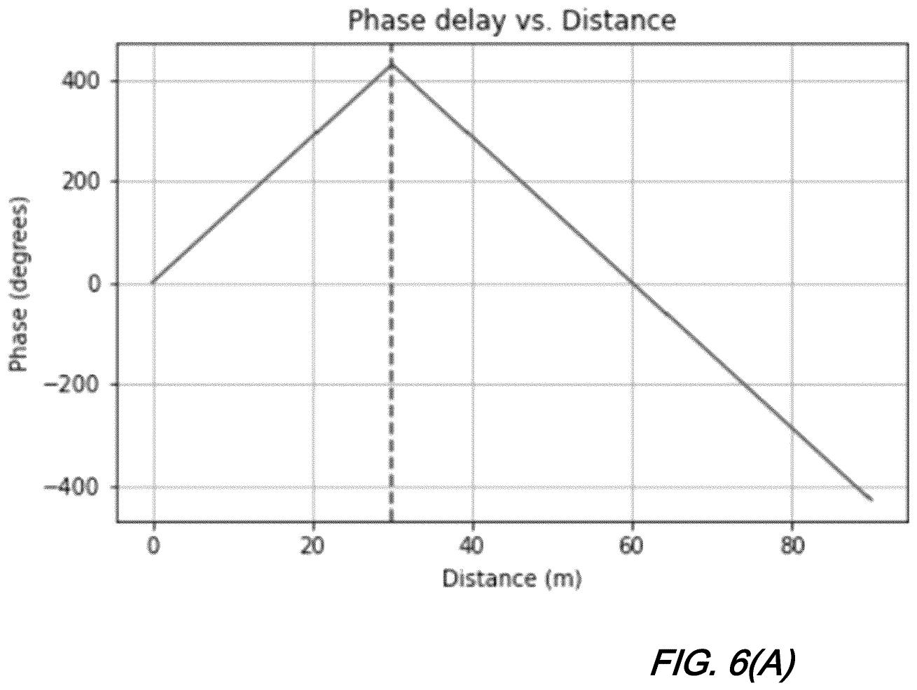

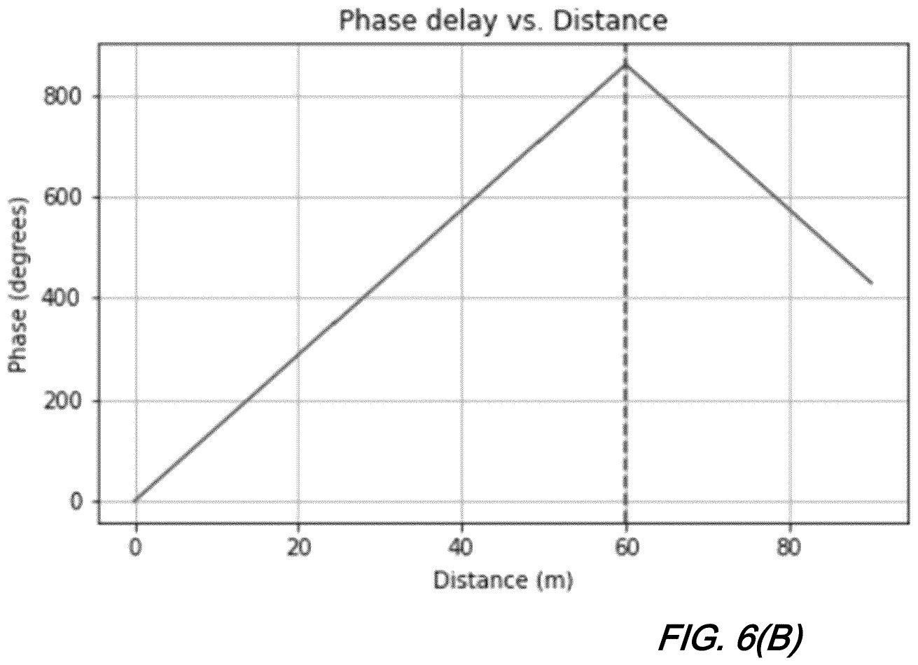

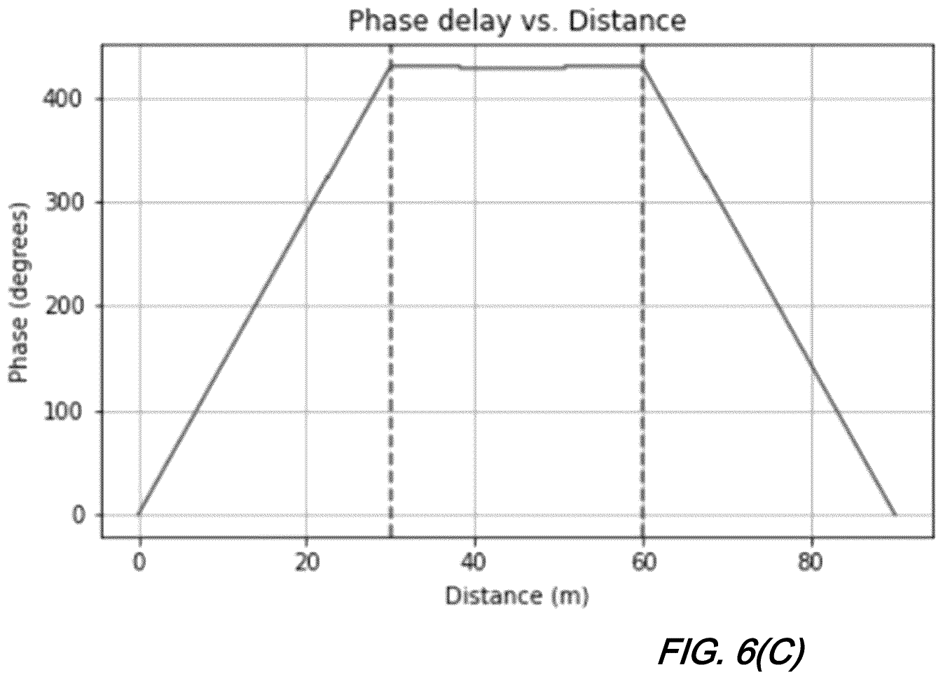

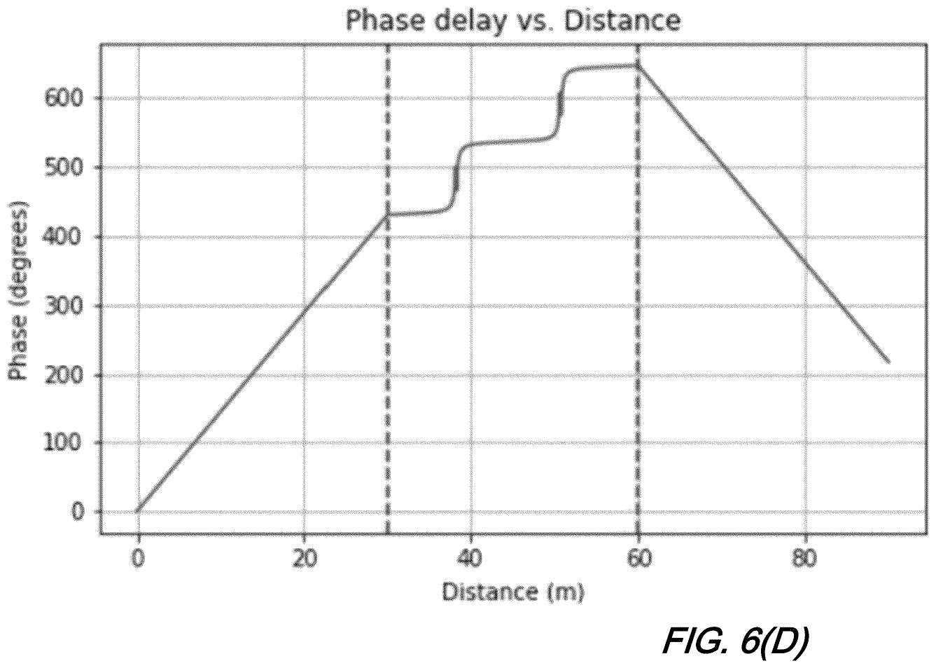

FIG. 6(A), FIG. 6(B), FIG. 6(C), and FIG. 6(D) are plots of phase delay vs distance showing phase shift across different locations with the location of the transformer signal source shown as a dotted line, in which: FIG. 6(A) shows only transformer signal1 is active; FIG. 6(B) shows only transformer signal2 is active; FIG. 6(C) shows both transformer signals are active and amplitude A=B; and FIG. 6(D) shows both transformer signals are active, and A≠B, according to aspects of the present disclosure.

These figures illustrate the phase delay across the locations in fiber cable, with the reference point set at the 0-meter mark. For singular transformer signal source, as shown in the FIGS. 4(a) and 4(b), the phase delay reaches its maximum at the signal source and linearly decrease in both directions along the cable.

This indicates that the phase at the signal source is leading relative to the phases in both directions. FIG. 4 (c) corresponds to the case No. (3), here we observe a consistent phase between 30 meters and 60 meters, due to the identical amplitude for the signal sources. Additionally, a more rapid increase in phase delay is evident in both directions. For FIG. 4 (d) where A≠B, there is a non-linear phase change between the two transformer signal sources. This characteristic serves as a distinctive feature when compare with the phase from a singular transformer source.

Step 3: Performing an experimental test at NECLA's real-scale utility pole testbed for data collection and analysis.

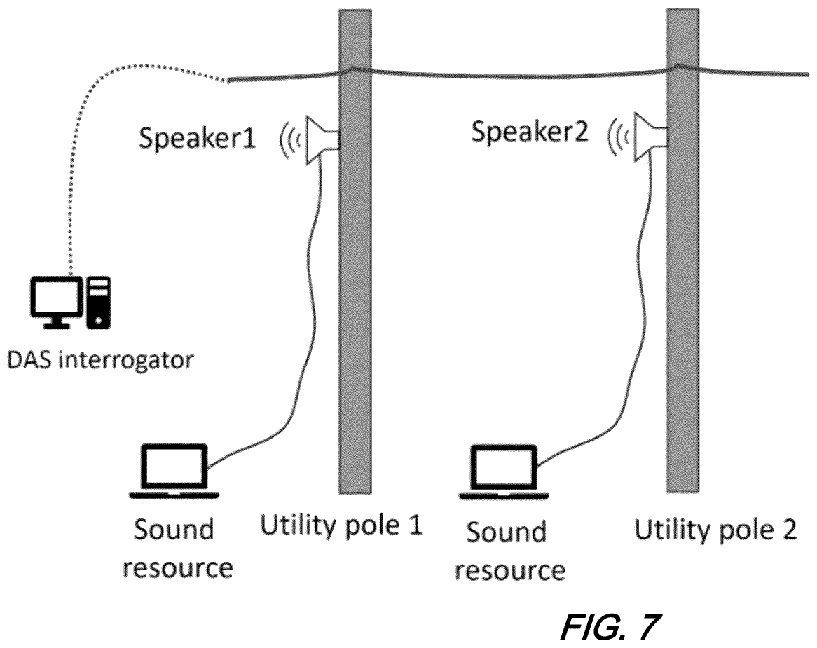

Taking it a step further, we execute an experimental test at our real-scale utility pole testbed. It allows us to control the transformer signal sources to validate a series of simulation results using fiber sensing technology. FIG. 7 illustrates the schematic of the experimental setup. A laptop connected with speaker on the utility pole, plays a 120 Hz tone to emulate the humming sound of transformer. We design a set of experiments mirroring simulation cases No. (1), No. (2), and No. (4)

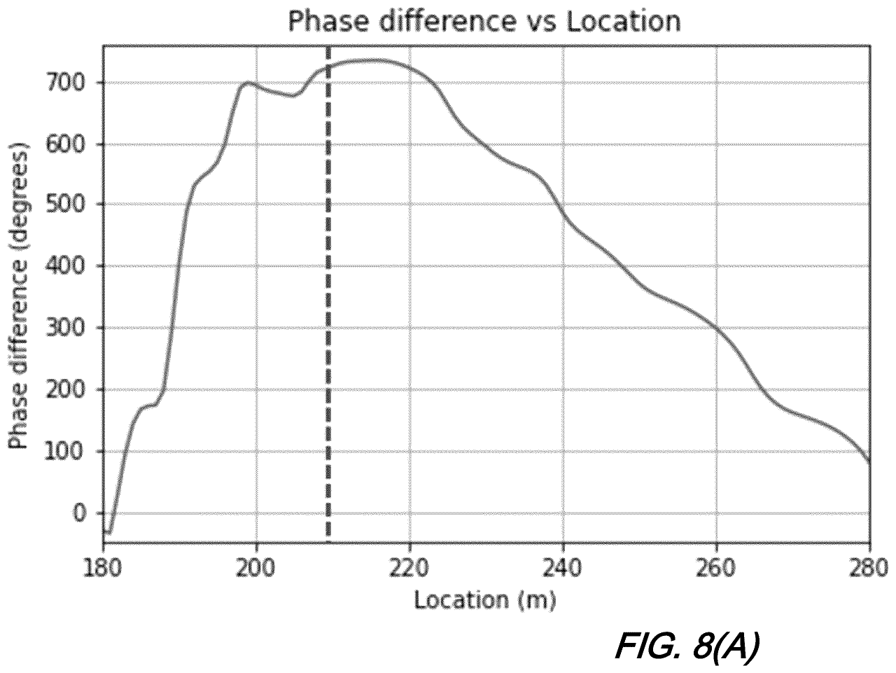

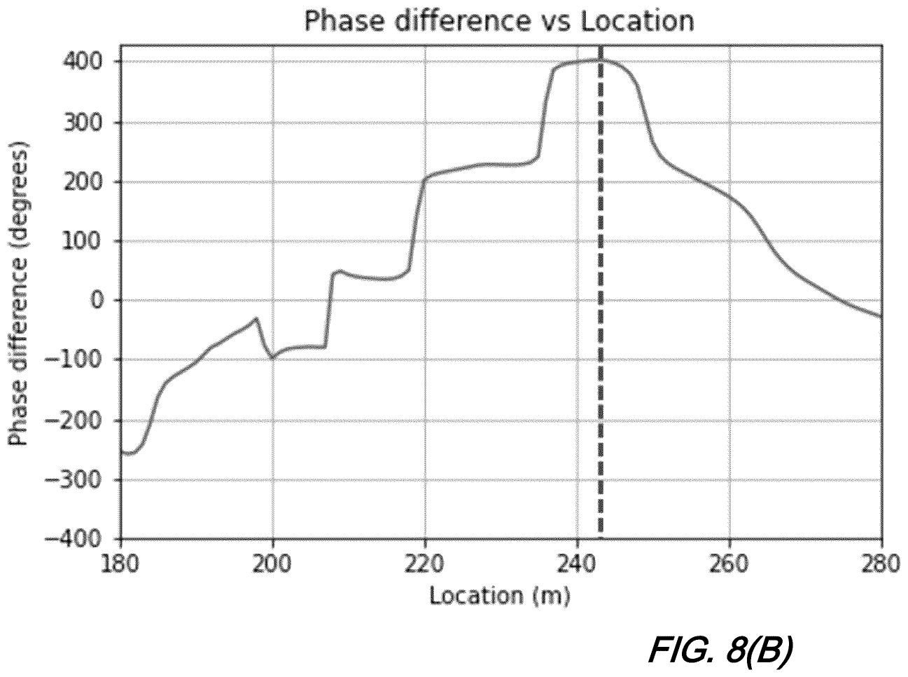

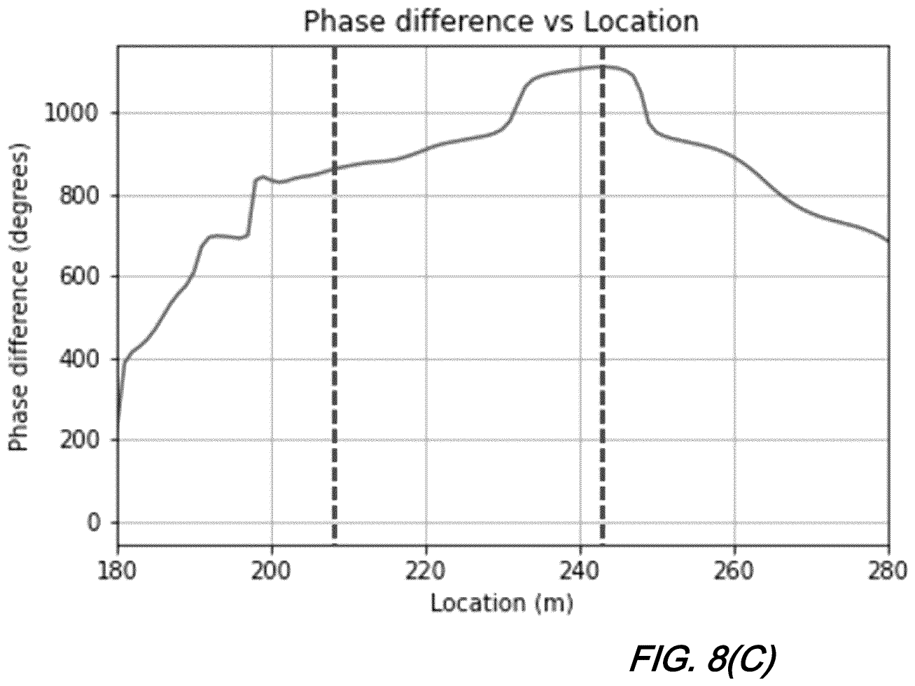

FIG. 8(A), FIG. 8(B), and FIG. 8(C) are plots of phase difference vs location showing phase shift across different locations with the dotted line showing the location of the utility pole in which: FIG. 8(A) shows only transformer signal1 is active; FIG. 8(B) shows only transformer signal2 is active; and FIG. 8(C) shows both transformer signals are active, according to aspects of the present disclosure.

These figures demonstrate the phase shift across the locations based on the data gathered by the DAS at the testbed. The phase delay curve exhibits a non-linear behavior, which can be attributed to the presence of ambient noise in the environment. In scenarios with a single transformer vibration source, as depicted in FIG. 8(A) and FIG. 8(B), there's a discernible change in the slope direction of the phase near the transformer's source location (red dotted line). However, when dealing with multiple transformers, this slope change on the two utility poles is absent.

Additionally, the changing slop of phase shift difference between the two poles is less steep in FIG. 8(C), compared to the situations with single transformer on, i.e. in FIG. 8(A) and FIG. 8(B). These observations align well with our simulation results. Consequently, if any transformer source experiences a malfunction, the phase delay pattern would also adjust correspondingly. This characteristic can be employed to monitor the transformer's operational status

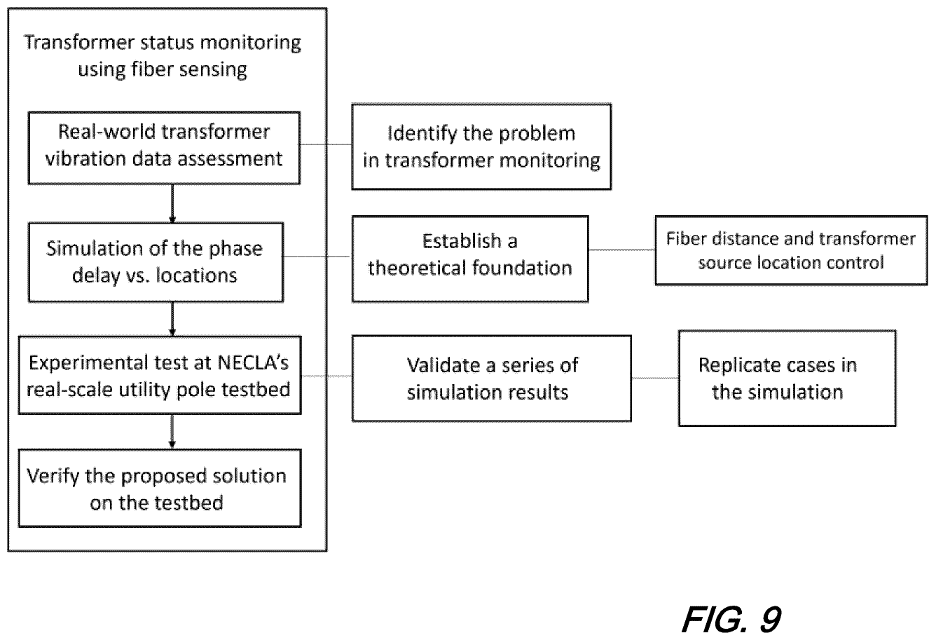

FIG. 9 is a schematic diagram showing illustrative features of systems and methods according to aspects of the present disclosure.

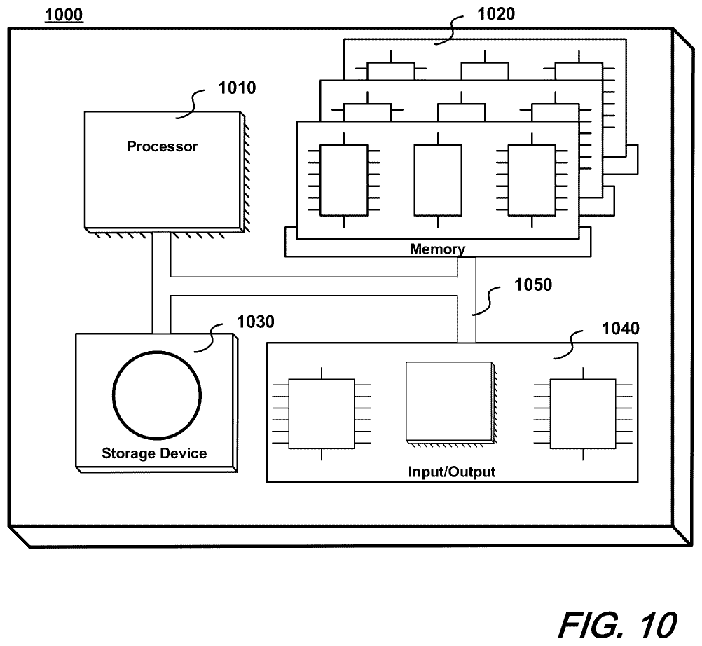

FIG. 10 is a schematic block diagram of an illustrative computing system that may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of a number of operating systems. The above-described methods of the present disclosure may be implemented on the computer system 1000 as stored program control instructions.

Computer system 1000 includes processor 1010, memory 1020, storage device 1030, and input/output structure 1040. One or more input/output devices may include a display 1045. One or more busses 1050 typically interconnect the components, 1010, 1020, 1030, and 1040. Processor 1010 may be a single or multi core. Additionally, the system may include accelerators etc., further comprising the system on a chip.

Processor 1010 executes instructions in which embodiments of the present disclosure may comprise steps described in one or more of the Drawing figures. Such instructions may be stored in memory 1020 or storage device 1030. Data and/or information may be received and output using one or more input/output devices.

Memory 1020 may store data and may be a computer-readable medium, such as volatile or non-volatile memory. Storage device 1030 may provide storage for system 1000 including for example, the previously described methods. In various aspects, storage device 1030 may be a flash memory device, a disk drive, an optical disk device, or a tape device employing magnetic, optical, or other recording technologies.

Input/output structures 1040 may provide input/output operations for system 1000.

While we have presented our inventive concepts and description using specific examples, our invention is not so limited. Accordingly, the scope of our invention should be considered in view of the following claims.

1. A method for determining transformer operational status, the method comprising:
operating a distributed fiber optic sensing (DFOS) system and capturing vibrations from a plurality of transformers;
determining, from the vibrations captured, transformer operational status of the one or more of the transformers from a phase delay of a 120 Hz vibration signal.

2. The method of claim 1 wherein a first one of the one or more transformers is operational, and a second one of the one or more transformers is non-operational; wherein the first and second transformer are positioned on utility poles that are immediately next to one another in a set of utility poles.

3. The method of claim 1 wherein a first one of the one or more transformers is non-operational, and a second one of the one or more transformers is operational; wherein the first and second transformer are positioned on utility poles that are immediately next to one another in a set of utility poles.

4. The method of claim 1 wherein a first one of the one or more transformers is operational, and a second one of the one or more transformers is operational and a 120 Hz signal from the first transformer exhibits an amplitude that is the same as an amplitude of a 120 Hz signal from the second transformer.

5. The method of claim 1 wherein a first one of the one or more transformers is operational, and a second one of the one or more transformers is operational and a 120 Hz signal from the first transformer exhibits an amplitude that is less than an amplitude of a 120 Hz signal from the second transformer.

6. The method of claim 2 wherein the phase delay is determined according to the following
φ(x)=2πf/c,
where x represents the distance to the signal source, f is the frequency 120 Hz, and c is the speed of sound in fiber set to 3000 m/s.

7. The method of claim 4 wherein a combined phase shift is determined using a Fast Fourier Transform (FFT) of the 120 Hz signals.
